(19) United States
(12) Patent Application Publication
(10) Pub. No.: US 2009/0130427 A1
(43) Pub. Date: May 21, 2009

(54) Nanomaterial facilitated laser transfer

(75) Inventors: Costas P. Grigoropoulos, Berkeley, CA (US); Seung H. KO, Berkeley, CA (US); Hee K. Park, San Jose, CA (US)

Correspondence Address: MICHAELSON & ASSOCIATES, P.O. BOX 8489, RED BANK, NJ, 07701-8489, US

(73) Assignees: The Regents of the University of California, Oakland, CA (US); AppliFlex LLC, Mountain View, CA (US)

(21) Appl. No.: 12/288,725

(22) Filed: Oct. 22, 2008

Related U.S. Application Data
(60) Provisional application No. 60/999,864, filed on Oct. 22, 2007.

(51) Int. Cl. B32B 5/16

(52) U.S. Cl. 428/323

(57) ABSTRACT

The invention relates to the deposition or transfer of material using a laser induced forward transfer process. More specifically, the invention relates to the transfer of material using a laser induced forward transfer process wherein the transfer process is facilitated or enabled by nanomaterials. Nanomaterials in the form of nanoparticles or nanofilms may be employed, optionally including a surface coating or self-assembled monolayer surface coating, making use of properties of the nanomaterials that allow the laser induced forward transfer process to be practiced at irradiation energies and temperatures lower than commonly used. The technique may be well suited for depositing organic layers.

### CROSS-REFERENCE TO RELATED APPLICATIONS

This application claims priority pursuant to 35 USC § 119 from provisional patent application Ser. No. 60/999,864 filed Oct. 22, 2007, the entire contents of which is incorporated herein by reference for all purposes.

### BACKGROUND OF THE INVENTION

1. Field of Invention

The invention relates to the deposition or transfer of material using a laser induced forward transfer process. More specifically, the invention relates to the transfer of material using a laser induced forward transfer process wherein the transfer process is facilitated by one or more nanomaterials.

2. Description of the Prior Art

Many technologies are enabled, facilitated or improved by the ability to pattern a wide variety of materials for specific purposes. A few examples of such technologies include microelectronics, flexible electronics, printed circuit boards, solar cells, liquid crystal displays (LCD), light emitting diodes (LED), and organic light emitting diodes (OLED), among others. Examples of patterning techniques that may be used for defining patterns in materials or depositing materials in desired patterns include contact lithography, projection lithography, screen printing, ink jet printing, and a variety of direct write technologies, among others.

Direct write technologies are often advantageous in that they allow the materials to be deposited, and patterns defined therein, quickly without the intermediate step of producing a mask, as is typically required for traditional lithography processes. A number of direct write technologies are known. Examples of direct write technologies include ink jet printing, laser chemical vapor deposition (LCVD), laser engineered nano-shaping (LENS), and laser induced forward transfer (LIFT), among others. The LIFT technology may be further subdivided into processes such as matrix assisted pulsed laser evaporation direct writing (MAPLE DW), laser induced thermal imaging (LITI), and laser induced pattern-wise sublimation (LIPS), among others.

Many of the direct write technologies exhibit a number of limitations. The ink jet printing and some variations of the LCVD techniques are wet techniques in that the material to be deposited must be combined with a liquid and sprayed onto the substrate. The liquid must be removed during a later processing step and the liquid removal may introduce contamination into the deposited material. Additionally, the minimum feature size is strongly influenced by properties of the fluid used to deliver the material of interest.

The laser-based techniques also exhibit a number of limitations. The material transfer process for these techniques involves the localized evaporation of the material of interest resulting from the temperature rise induced at the impact point of the laser beam. Laser-based techniques have been used successfully to deposit metals, conductive films, inorganic dielectric films, and ceramics.

Laser-based techniques have been previously investigated for the deposition of organic materials with limited success. Generally, organic compounds have high vapor pressures and are easily damaged by high temperatures. The damage may be caused by the direct thermal decomposition or degradation of the organic material, or may be caused by the reaction of the organic material with gaseous species in the environment at elevated temperatures.

Organic light emitting diode (OLED) displays have a number of desirable features such as high contrast, high brightness, wide color range, thin structure, and light weight, among others. OLED displays have a number of manufacturing requirements such as large area, increasing needs for smaller feature sizes, increasingly stringent control requirements on the feature shape, high yield, and low cost. All such factors tend to limit the manufacturing techniques that may be employed.

Traditional lithography and thermal evaporation deposition techniques have significant disadvantages, among which is the need for masks which are typically difficult to make to the required specifications at a reasonable price. Therefore, OLED display manufacturing makes extensive use of direct write techniques for patterning the various materials used in constructing the display.

Thus, there is a need for improved direct write techniques, especially (but not limited to) improved techniques suitable for use with organic materials.

### SUMMARY OF THE INVENTION

Accordingly and advantageously the present invention relates to methods, materials, systems, and/or devices for the deposition and/or removal of a material of interest onto and/or from a substrate using one or more nanomaterials and/or nanoparticles to enable or to facilitate the deposition/removal. Some embodiments of the present invention relate to methods for the deposition of a material on a substrate without the use of a mask. Some embodiments of the present invention relate to methods for the deposition of a wide range of materials on a substrate wherein typical materials may include metals, metal alloys, metal compounds, inorganic dielectric layers, organic dielectric layers, inorganic semiconductor layers, organic semiconductor layers, organic conducting layers, polymers, glasses, and ceramics, among others. Some embodiments of the present invention relate to methods for the deposition of a material on a substrate using an energy source wherein typical energy sources may include a pulsed laser, a continuous wave laser, a pulsed lamp, a continuous wave lamp, and an LED, among others. Some embodiments of the present invention relate to methods for the deposition of a material on a substrate wherein at least a portion of the deposited material forms some or all of the desired pattern. Some embodiments of the present invention relate to methods for the removal of a material from a substrate wherein the material remaining on the substrate after removal forms some or all of the desired pattern.

At least one of these and/or other advantages are achieved in accordance with the present invention as described in detail below.

### BRIEF DESCRIPTION OF THE DRAWINGS

The drawings herein are not to scale and the depictions of relative sizes and scale of components within a drawing are schematic and also not to scale.

The techniques of the present invention may be readily understood by considering the following detailed description in conjunction with the accompanying drawings, in which:

FIG. 1 is a qualitative illustration of the absorption characteristics of a typical OLED material.

FIG. 2 is an illustration of the absorption depth versus wavelength for 5 nm Au nanoparticles for Rayleigh and Mie absorption and also indicates a wavelength with particularly strong absorption (small absorption depth.)

FIGS. 3a-d are photographs of time resolved shadowgraph images of ablation from both sintered and unsintered Au nanoparticle donor films.

FIG. 4 is a schematic illustration of one possible laser system according to some embodiments of the present invention.

FIG. 5 is a schematic illustration of the nanoparticle enabled laser induced transfer method according to some embodiments of the present invention.

FIGS. 6a-c are photographs of structures deposited using the nanoparticle enabled laser induced transfer method according to some embodiments of the present invention.

FIGS. 7a-f are photographs of structures deposited using the nanoparticle enabled laser induced transfer method according to some embodiments of the present invention.

FIGS. 8a-f are photographs of structures deposited using the nanoparticle enabled laser induced transfer method according to some embodiments of the present invention.

FIG. 9 is a schematic illustration of the nanomaterial enabled laser induced transfer method according to some embodiments of the present invention.

FIGS. 10a and 10b are photographs of fluorescence patterns that are obtained when transfer is performed with excessive laser energy (10a) in comparison with fluorescence patterns resulting from proper laser energy (10b).

### DETAILED DESCRIPTION

After considering the description herein, those skilled in the art will clearly realize that the teachings of the invention may be readily utilized in transferring, removing, and/or patterning materials for use in a variety of technologies.

The present invention relates to the deposition, removal and/or transfer of material using a forward transfer process (herein “transferred” for economy of language), employing an energy source. The energy source is typically a laser or other radiation source producing adequate energy delivery to the material to be transferred. As noted above, the energy source can be a pulsed or continuous wave laser, or other sources of light or electromagnetic radiation delivering adequate energy to the material to be transferred. For economy of language we denote all such energy sources herein as “laser,” understanding thereby that other energy sources may be used to accomplish substantially similar or equivalent results.

In addition, for economy of language we refer to the processes described herein as nanomaterial “enabled,” or “facilitated” without distinction. In both cases, we include therein processes that are improved or facilitated by the presence of nanomaterials as well as processes that do not occur in the absence of nanomaterials.

In addition, for economy of language we refer to the materials described herein as “nanomaterials” including therein materials comprised of assemblies of nanoparticles, thin films of less than about 100 nm in thickness, and materials composed of structures with dimensions of less than about 100 nm in at least one direction. Examples of such structures may include particles, tubes, balls, cages, or other common geometric shapes.

Material transfer techniques based upon laser induced forward transfer (LIFT) are an area of active research and development. Briefly, LIFT employs a donor substrate having a first face and a second face and coated with the material (or materials) of interest on, say, the second face. The substrate is typically chosen so that it is substantially transparent to the wavelength of the laser chosen for the technique. The laser beam can thus be directed onto the first face of the donor substrate and may pass through the donor substrate without losing a significant amount of energy, that is, with the delivery to the second face of sufficient laser light energy so as to perform the desired material transfer at the second face.

The laser light is typically absorbed at or near the second face of the donor substrate, at or near the material to be transferred (or “material of interest”). In general, there may be one or more layers on the second face of the donor substrate that are reasonably transparent to the laser light, not absorbing enough intensity to interfere in any substantial way with the desired material transfer. Such intermediate transparent layers may be advantageously used (for example) to facilitate the adhesion between the second face of the donor substrate and the material to be transferred, to prevent deleterious chemical interactions between the donor substrate and the material to be transferred, or for other purposes.

The material of interest may become heated by the direct absorption of the laser light, or by the absorption of the laser light in a nearby layer and conductive heat transfer to the material of interest. Thus, the material of interest may undergo local evaporation in the region where the laser beam is incident.

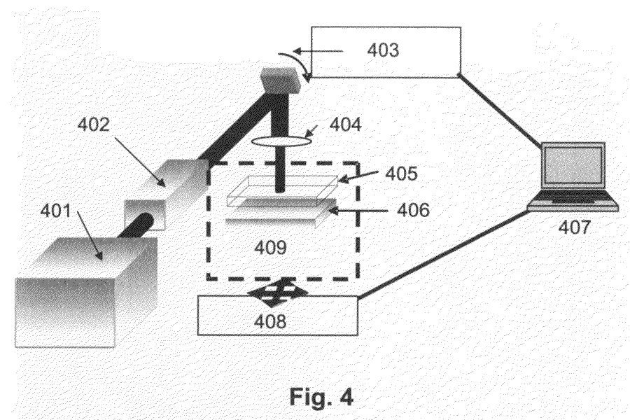

An acceptor substrate is typically placed in close proximity to the donor substrate having a face of the acceptor substrate (the “first face”) onto which transfer of material is desired, placed across from and in close proximity with the second face of the donor substrate as depicted (for example) in FIGS. 4, 5, and 9.

The material of interest that is evaporated or ejected from the second face of the donor substrate may impinge on the first face of the acceptor substrate and may be deposited upon the first face of the acceptor substrate. As the laser beam is translated across the first face of the donor substrate (opposite to the face with the material to be transferred) to form the desired pattern, a corresponding pattern of the material of interest may become deposited upon the first face of the acceptor substrate. The donor substrate and the acceptor substrate may be held in close proximity or may be held in intimate contact. The environment between the donor substrate and the acceptor substrate may comprise ambient air, inert gases, reactive gases, or vacuum, among others.

The LIFT technique has substantial challenges to overcome when applied to the transfer and/or patterning of organic materials. The absorption of the laser light and the resulting local heating often damage the organic material before sufficient evaporation has occurred to transfer the material to the acceptor substrate. The resulting deposited material on the acceptor substrate may not have the desired properties for the intended use. Some techniques for attacking this overheating problem include placing a light absorbing matrix material between the organic material of interest and the second face of the donor substrate. The properties of the matrix material may be such that the vapor pressure of the matrix material is higher than the organic material of interest causing the matrix material to heat and evaporate before the organic material of interest is damaged. The evaporation of the matrix material may thus induce the transfer of the organic material of interest from the donor substrate to the acceptor substrate. However, while the conventional LIFT technique may be enhanced by careful engineering of the matrix material, the properties of the matrix materials are often sufficiently similar to those of the organic materials of interest such that the heating of the organic materials of interest remains unacceptably high.

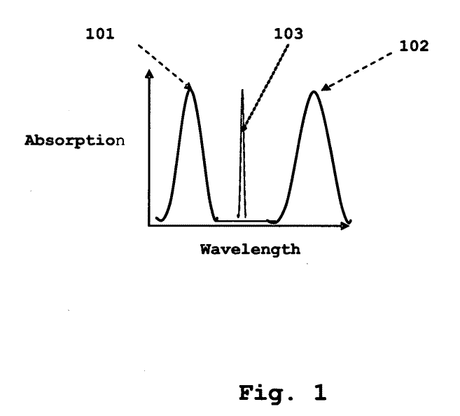

FIG. 1 shows an illustration of the absorption characteristics of a typical organic material. Typically, organic materials have strong absorption bands in the ultraviolet (UV) region of the spectrum, illustrated by the short wavelength peak 101, typically corresponding to absorption resulting from electronic phenomena occurring in the organic material. Additionally, organic materials may have strong absorption bands in the infra-red (IR) region, illustrated by the long wavelength peak 102 generally corresponding to vibrational absorption phenomena. Many organic materials may also have weak absorption bands in the intermediate visible region between peaks 101 and 102, but these typically do not cause significant absorption. Therefore, laser wavelengths in this intermediate visible region may interact only weakly with the organic material of interest and may be an advantageous spectral region in which to seek a matrix material that has substantial absorption in this region, leading to effective evaporation and effective transfer of material. The central peak 103 illustrated in FIG. 1 indicates a typical suitable laser wavelength for the LIFT technique that will be absorbed strongly by a properly engineered matrix material while interacting only weakly with the organic material of interest.

In some embodiments of the present invention, the matrix (or light absorption) material may be comprised of a layer of nanoparticles wherein the nanoparticles are protected by a surface coating. Many nanomaterials, including nanoparticles, exhibit properties substantially different from those observed in bulk materials due to the nanoparticles' large surface-to-volume ratio, large surface energy, and the confinement of molecules, atoms, and electrons in a small spatial region. The nanoparticles may be formed from any suitable material. Examples of such suitable materials may include, but are not limited to, metals (examples include Au, Ag, Pt, Pd, Cu, Ni, Cr, Ti, Fe, Zn, W, Si, and Al among others), metal alloys, metal compounds (examples comprise ZnO, TiO₂, Indium Tin Oxide, MnTiO₃, CoAl₂O₄ and CuO among others), inorganic dielectric materials (examples include SiO₂ and Si₃N₄ among others), organic dielectric materials, inorganic semiconductor materials, organic semiconductor materials, polymers (examples include polystyrene, melamine resin, and PMMA-polymethylmethacrylate, among others), glasses, and ceramics, among others.

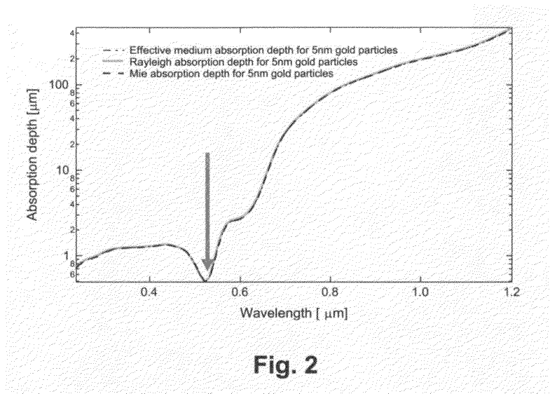

Proper selection of nanoparticle size and size distribution, as well as the material type (or types) may allow very efficient laser energy coupling and easy tuning of at least one laser absorption peak. The incident laser pulse energy may be absorbed by nanoparticles more efficiently than a bulk thin film of the same material, largely due to smaller reflectance and strong absorption occurring in nanoparticles in comparison with the bulk material. Noble metal nanoparticles such as Au and Ag exhibit strong absorption peaks in the visible wavelength region that are typically not observed in the bulk materials, and considered to be due to surface plasmon oscillation modes of conduction electrons in the nanoparticles. This is illustrated in FIG. 2 where the absorption depth of 5 nm (nm=nanometer=10⁻⁹ meters) Au nanoparticles is shown as a function of wavelength. Although two absorption mechanisms are depicted, Rayleigh absorption and Mie absorption, the curves are substantially identical and indistinguishable on the scale of FIG. 2. The arrow at about 0.52 μm indicates the approximate wavelength at which particularly strong absorption occurs (μm=micron=10⁻⁶ meter=1000 nm). This “effective medium absorption depth for 5 nm gold nanoparticles” illustrates that the 5 nm nanoparticles have a strong absorption (small absorption depth) in the visible wavelength region at a wavelength of about 520 nm (i.e., 0.52 μm). The wavelength at which this strong absorption occurs depends on specific properties of the nanoparticles such as nanoparticle material(s) used, and size, among other properties. Thus, the nanoparticles absorption characteristics can be engineered. Additionally, enhanced electric fields between nanoparticles may contribute to more efficient energy absorption mechanisms as discussed by Choi et al, Appl. Phys. Lett., Vol. 85, pp. 13-15 (2004), the entire contents of which is incorporated herein by reference for all purposes.

For efficient energy absorption, the deposited energy may be more confined to the laser focal or impact spot due to the reduced thermal diffusion of nanoparticle thin films. That is, the relatively lower thermal conductivity of a nanoparticle thin film reduces the rate of dissipation of energy away from the spot where evaporation and transfer is desired, thereby facilitating the heating, evaporation, and transfer at the desired location. The relatively low thermal conductivity of nanoparticle materials has been demonstrated in the field of thermoelectric energy conversion, as discussed by Kim et al, Phys. Rev. Lett. Vol. 96, pp. 045901-1,-4 (2006), the entire contents of which is incorporated herein by reference for all purposes. The thermal conductivity of nanoparticle film may be determined by the presence of the interface that induces phonon reflection (Kapitza resistance) or phonon scattering. It is reported that Au—Pd nanoparticles stabilized by alkanethiol surface coatings have very small thermal conductance of about (5 MW/m²•K) due to the vibrational mismatch between the nanoparticle solid core and the surface coating. See Wilson et al., Phys. Rev. B, Vol. 66, pp. 224301-1,-6 (2002), the entire contents of which is incorporated herein by reference for all purposes.

The alkanethiol surface coating referred to above is an example of a self-assembled monolayer, SAM. The alkanethiol SAM on the Au nanoparticle forms with the sulfur-end of the alkanethiol bonding to the Au nanoparticle surface and the alkane chains aligned to form an aligned surface structure. This SAM coating is one example of a coating applied to nanoparticles that serves to stabilize the nanoparticles (Au in this case) and prevent coalescence into larger clusters or into a bulk film.

The absorbed energy may induce nanoparticle melting and sufficient energy may be transferred to the SAM coating or residual solvent to cause evaporation. The SAM coating may be comprised of any suitable material. Examples of such suitable materials include, but are not limited to, alkanethiols, alkyltrichlorosilanes, fatty acids, thin metal shell or metal oxide shell (with polymer or metal core), polymers such as poly(pyrrole), poly(aniline), poly(alkylcyanoacrylates), poly(methylidene malonate), and polyesters such as poly(lactic acid), poly(glycolic acid), poly(Σ-caprolactone) and their copolymers.

Although SAM materials are advantageous in many cases, it is not a requirement that the coating material exhibit self-assembling behavior. It is desirable that the surface coating form a thin protective sheath on the nanoparticles. The melting temperature depression may thus enable ablation driven by the nanomaterial material melting and vaporizing at much lower laser energy than for bulk materials.

Upon reaching the SAM desorption temperature (typically from about 150° C. to about 250° C.), the SAM coatings may desorb. At this stage, molten-like nanoparticles, that may exhibit liquid-like properties due to their large surface area, may agglomerate to form larger molten-like particles that may be expelled by the pressure built up from the expansion of volatile species, such as desorbed SAM, residual organic solvent, and trapped gases. Additionally, due to the presence of the SAM coating (below the SAM desorption temperature), the nanoparticles are typically held together by weak physical van der Waals forces, that is, weak compared with the strong polycrystalline metal bonding in sintered nanoparticle films. Therefore, the expulsion may be enhanced by the relatively weak bonding between the nanoparticles.

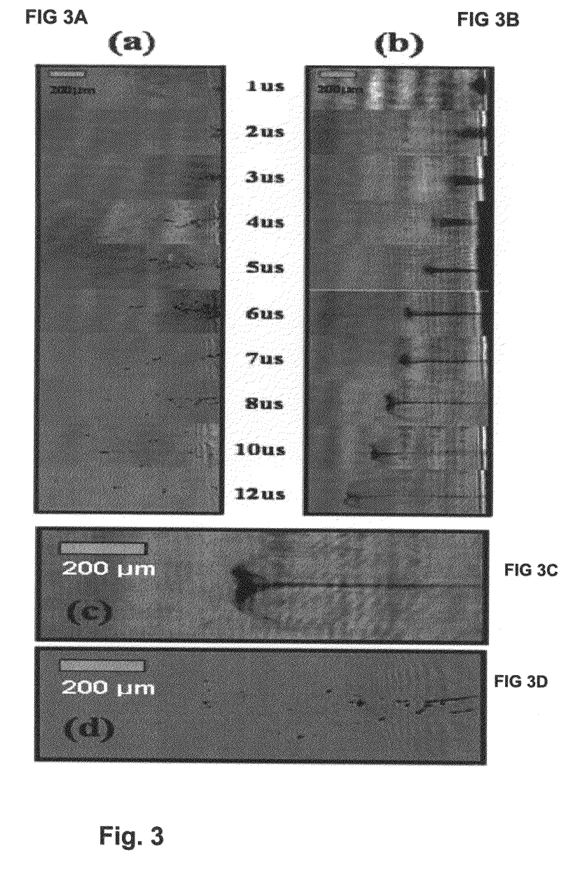

The combined effects of melting temperature depression, lower conductive heat transfer loss, strong absorption of the incident laser beam, and relatively weak bonding between nanoparticles during laser irradiation may result in the nanoparticle materials having an ablation threshold energy fluence of one or two orders of magnitude lower than the threshold for the bulk film. This low ablation threshold may allow the LIFT technique to be employed at lower laser energies. FIGS. 3a-d contain time resolved shadowgraph images of the ablation plume ejection from a sintered nanoparticle film (FIG. 3-a, FIG. 3-d) and from an unsintered nanoparticle film (FIG. 3-b, FIG. 3-c) over the time period of 1 μs to 12 μs (μs=microseconds=10⁻⁶ second). While micrometer (10⁻⁶ meter) sized molten droplets were ejected from the sintered nanoparticle film at a velocity of 40 m/s (FIG. 3-d), unsintered nanoparticle ablation produced mist jet-like ejecta (FIG. 3-c) at almost the same velocity but exhibiting good directionality. We have observed mist jet-like ejection plumes in the ablation of organic materials such as photo-decomposable polymers suggesting that the SAM coating may play a similar role during the ablation of the unsintered nanoparticle film. The unsintered nanoparticles may be protected by the organic surface coating and may be loosely bonded like decomposed polymer chains as discussed, for example, in Ko et al, Appl. Phys. Lett., Vol. 89, pp. 141126 (2006) and Ko et al, J. Appl. Phys., Vol. 102, pp. 093102 (2007). The entire contents of the preceding references are incorporated herein by reference for all purposes.

FIG. 4 is a schematic illustration of one possible laser system according to some embodiments of the present invention. The system may typically include a Nd:YAG laser 401 (generally frequency doubled to 532 nm wavelength, and having a 5 ns pulse width), a laser beam homogenizer 402, and a 3-axis translation stage 408 and mirrors 403 under the control of computer system 407. The laser or other energy source may be selected according to the particular nanomaterial to be used. The energy source may be a pulsed laser, a continuous wave laser, a pulsed lamp, a continuous wave lamp, and an LED, among others. For typical examples, the Nd:YAG laser beam cross-section is typically shaped to a size in the range from approximately 0.8 mm² to approximately 2 mm² square, and a beam profile of good spatial uniformity can be achieved by using a micro-lens laser beam homogenizer 402 combined with a 10× long working distance objective lens 404. In some embodiments of the present invention, the LIFT technique was performed in an ambient air environment but it may also be performed in a vacuum chamber or controlled environmental chamber to minimize environmental gas effects. This region in which the ambient conditions of the material transfer process can be controlled (if needed) is indicated schematically as square 409 in FIG. 4. Region 409 in FIG. 4 may be filled with ambient air, inert gases, reactive gases, or vacuum, among others as desired. The donor substrate is indicated as 405 and the acceptor substrate is indicated as 406.

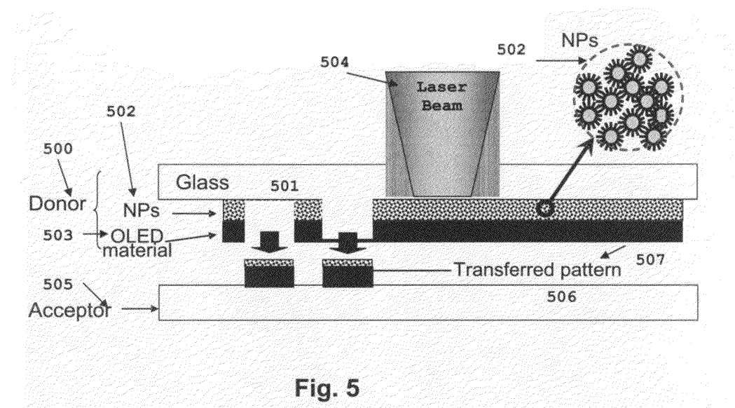

FIG. 5 is a schematic illustration of a typical nanoparticle enabled laser induced transfer according to some embodiments of the present invention. The donor substrate structure 500 typically has first and second surfaces (although more complex, and non-rectangular shapes are not excluded). The second surface of the donor substrate typically supports a multilayer film comprised of the target deposition material 503, nanoparticle film 502, formed on the substrate 501, typically a glass substrate. The target deposition material 503 may be formed from any suitable material. Examples of such suitable materials include, but are not limited to, metals, metal alloys, metal compounds, inorganic dielectric materials, organic dielectric materials, inorganic semiconductor materials, organic semiconductor materials, polymers, glasses, and ceramics, among others. The nanoparticle film 502 may include nanoparticles protected by a coating, advantageously a SAM coating, as illustrated by the “NPs” in the dotted insert portion of the drawing. The nanoparticles may be composed of any suitable material. The acceptor substrate structure 505 may be comprised of any useful material 506. In some embodiments of the present invention, the acceptor substrate structure 505 may be a substrate material 506 with coatings or other useful structures for the manufacture of the target device. The donor substrate structure 500 may be placed face down on the acceptor substrate structure 505. The surfaces may be in close proximity or they may be touching. A Nd:YAG laser beam 504 may be directed onto the first surface (top) of the donor substrate 501. The laser beam energy is advantageously chosen such that it does not interact strongly with the donor substrate material but may be strongly absorbed by the nanoparticle film 502. Heat is transferred to the SAM coating or to the gas between the nanoparticles. The pressure may rapidly build from the volatile species expansion (such as desorbed SAM, residual organic solvent, and trapped air) to eject the nanoparticle film and detach the target material 503 from the donor substrate. The target material may impinge upon the first surface of the acceptor substrate 506 and result in the formation of the desired pattern 507.

### EXAMPLE 1

In this example, the target deposition material of interest was chosen as an organic material (tris-(8-hydroxyquinoline)Al) (Alq₃). Alq₃ is an organic material commonly used in the manufacture of OLED displays. The light absorption material was formed from Ag nanoparticles having sizes in the range from about 30 nm to about 40 nm in diameter and protected with an organic SAM coating. The SAM coating may be applied to the Ag nanoparticles by a well known two-phase reduction method as discussed, for example, by Hostetler et al, Langmuir 1998, Vol. 14(1), pp. 17-30 (1998), the entire contents of which is incorporated herein by reference for all purposes. Aqueous metal salts are mixed in a toluene solution containing long-chain alkylammonium surfactants to form a two-phase system. Vigorous stirring for about 1 hour to about 3 hours transfers the metal salts into the organic phase, which is then separated. A measured quantity of surface monolayer, hexanethiol is added to the organic phase, and then a reducing agent (such as NaBH₄) is added to nucleate the nanoparticles. The Ag nanoparticles were suspended in ethanol and can be spin coated or drop coated onto a glass substrate to form a matrix layer of approximately 100 nm to 200 nm thickness.

The Alq₃ layer was deposited by a resonant infrared pulsed laser deposition (RIR-PLD) technique. In this method, Alq₃ powder was compressed into a pellet, which was irradiated by a pulsed, infrared laser at the wavelength of 6.67 μm. The 6.67 μm wavelength corresponds to a vibrational absorption band, aromatic ring stretch, of the Alq₃ molecule, inducing an effective evaporation. The donor substrate was positioned a few centimeters away from the pellet target to collect the evaporation plume of Alq₃. However, traditional thermal evaporation can also be used to deposit the Alq₃ layer. The donor substrate was then placed in intimate contact with the acceptor substrate. The Nd:YAG laser beam was directed toward the first surface of the donor substrate where it passed through the glass substrate and was absorbed by the Ag nanoparticle light absorption layer. The local heating of the Ag nanoparticle light absorption layer induced the transfer of the Alq₃ material from the second surface of the donor substrate onto the first surface of the acceptor substrate.

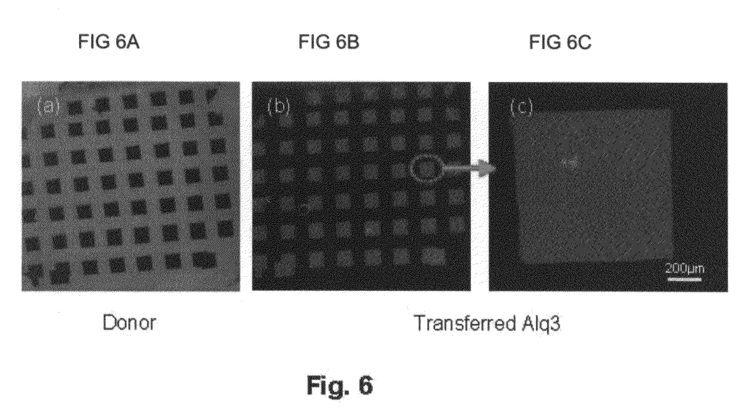

FIGS. 6a-c are photographs of the Alq₃ layers under UV illumination. Under UV illumination, the Alq₃ layer will fluoresce. The fluorescence of the Alq₃ layer may serve as an indication of damage to the material. If the Alq₃ layer becomes damaged, the layer will cease to fluoresce or the intensity will be greatly reduced. FIG. 6a contains a photograph of the second surface of the donor substrate after laser irradiation and material transfer. The black squares correspond to regions where the laser irradiation resulted in the transfer of the Alq₃ material from the donor substrate to the acceptor substrate. The squares are 0.9 mm by 0.9 mm and have a 2 mm pitch between adjacent squares. The fluorescence of the Alq₃ layer is strong indication that the surrounding Alq₃ layer was not significantly damaged by the transfer process. Therefore, one may conclude that the thermal energy did not diffuse laterally to a significant extent.

FIG. 6b contains a photograph of the first surface of the acceptor substrate after laser irradiation and material transfer. The green squares correspond to regions where the laser irradiation resulted in the transfer of the Alq₃ material from the donor substrate to the acceptor substrate. The fluorescence of the Alq₃ squares is strong indication that the transferred Alq₃ layer was not significantly damaged by the transfer process. The Alq₃ layer may be expected to show a strong decrease in fluorescence if the temperature exceeds about 300° C. Therefore, one may conclude from this evidence that the Alq₃ layer did not encounter temperatures above about 300° C. during the transfer process. The squares are 0.9 mm by 0.9 mm and have a 2 mm pitch between adjacent squares. The thickness of the transferred layer is typically about 100 nm to 200 nm corresponding to the thickness of the Alq₃ layer on the donor substrate structure as well as a small amount of the nanoparticle matrix layer. This is strong evidence that the transfer was quite efficient and that the squares are well defined and correspond closely to the inverse pattern observed on the donor substrate.

In this example, the first surface of the acceptor substrate contained a coating of polydimethylsilane (PDMS) which serves as an adhesion promotion layer to enhance the adhesion of the Alq₃ layer to the acceptor substrate.

FIG. 6c contains a photograph of one of the Alq₃ squares transferred to the acceptor substrate at greater magnification. The fluorescence of the Alq₃ square is strong and uniform, indicating that the transferred Alq₃ layer was not significantly damaged by the transfer process. Additionally, the edges of the square are sharp and well defined indicating that the spatial control of the transfer process is accurate and precise. In the example illustrated in FIGS. 6a-c, the transfer was facilitated by a single laser pulse of 1.04 mJ at each square to induce the transfer.

### EXAMPLE 2

Donor and acceptor surfaces were prepared as described in Example 1 and different transfer conditions and patterns were investigated.

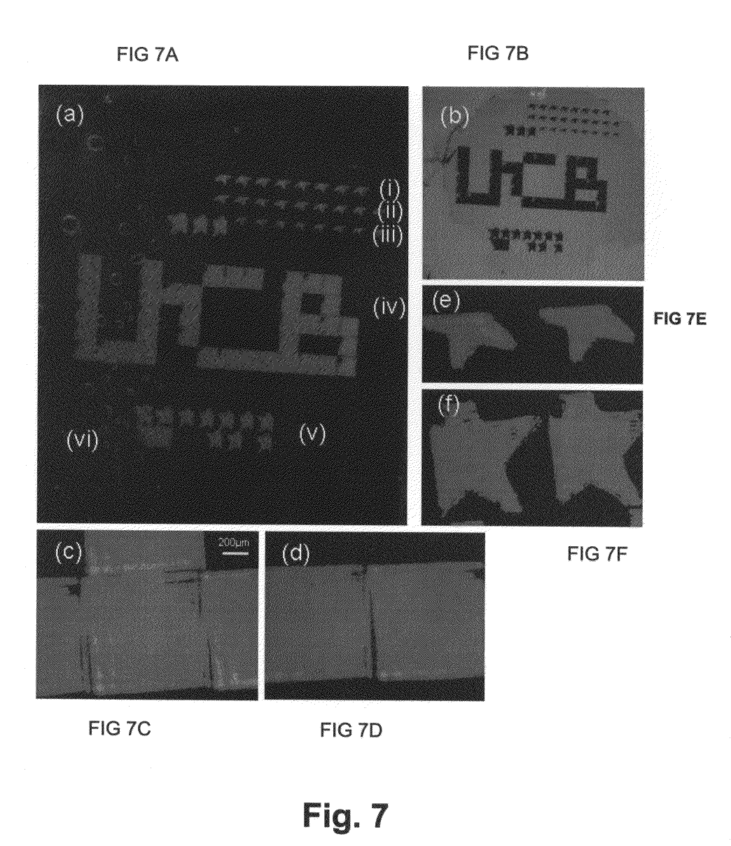

FIGS. 7a-f are photographs of the Alq₃ layers under UV illumination. FIG. 7a contains a photograph of the first surface of the acceptor substrate after laser irradiation and material transfer. The green letters “UCB” and the star shapes correspond to regions where the laser irradiation resulted in the transfer of the Alq₃ material from the donor substrate to the acceptor substrate. The “UCB” letters were formed from combining the 0.9 mm by 0.9 mm square shapes discussed in Example 1. The star shapes were formed by projecting the laser beam through a mask containing star shapes before the laser beam reached the donor substrate structure. The fluorescence of the Alq₃ shapes provides strong evidence that the transferred Alq₃ layer was not significantly damaged by the transfer process.

In FIG. 7a, the line of stars indicated at (i) was patterned using a laser pulse energy of 1.63 mJ. In FIG. 7a, the line of stars indicated at (ii) was patterned using a laser pulse energy of 1.04 mJ. In FIG. 7a, the line of stars indicated at (iii) was patterned using a laser pulse energy of 0.59 mJ. In FIG. 7a, the “UCB” letters at (iv) and the line of stars indicated at (V) were patterned using a laser pulse energy of 0.59 mJ. In FIG. 7a, the bubbles appearing as indicated at (vi) (and elsewhere in the figure) were determined to be in the PDMS adhesion layer and not a result of the Alq₃ layer transfer process. In all cases, the shapes are well defined and the fluorescence of the Alq₃ is strong indication that the Alq₃ layer was not damaged during the transfer process.

FIG. 7b contains a photograph of the second surface of the donor substrate after laser irradiation and material transfer. The transfer appears to be complete and the surrounding Alq₃ layer has not been significantly damaged.

FIGS. 7c-f are photographs of some of the Alq₃ squares and stars transferred to the acceptor substrate in greater magnification. The fluorescence of the Alq₃ shapes is strong and uniform indicating that the transferred Alq₃ layer was not significantly damaged by the transfer process. Additionally, the edges of the shapes are sharp and well defined indicating that the spatial control of the transfer process accurate and precise.

### EXAMPLE 3

Donor and acceptor surfaces were prepared as described in Example 1 and different transfer conditions and patterns were investigated.

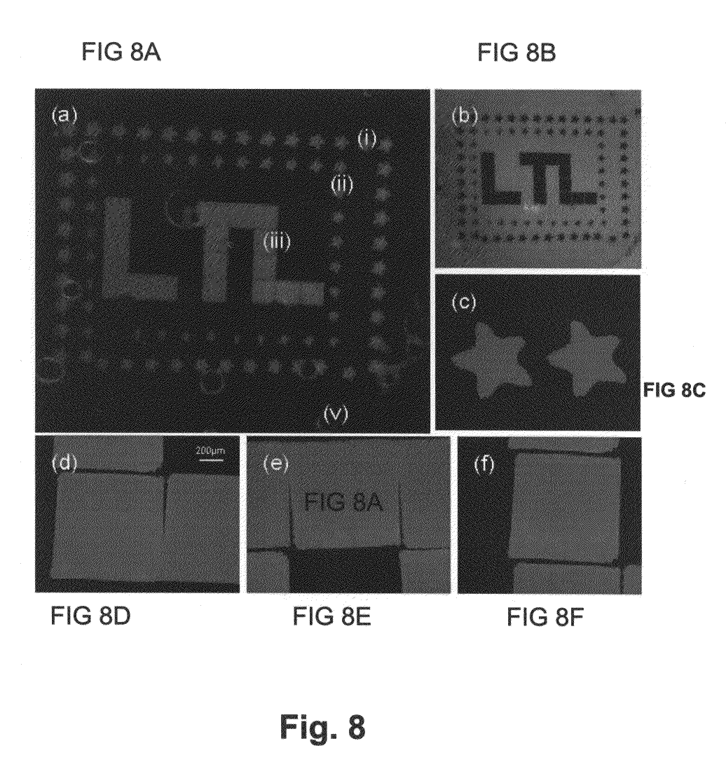

FIGS. 8a-f contain photographs of the Alq₃ layers under UV illumination. FIG. 8a contains a photograph of the first surface of the acceptor substrate after laser irradiation and material transfer. The green letters “LTL” and the star shapes correspond to regions where the laser irradiation resulted in the transfer of the Alq₃ material from the donor substrate to the acceptor substrate. The “LTL” letters were formed by combining 0.9 mm by 0.9 mm square shapes discussed in Example 1. The star shapes were formed by projecting the laser beam through a mask containing star shapes before the laser beam reached the donor substrate structure. The fluorescence of the Alq₃ shapes is strong indication that the transferred Alq₃ layer was not damaged by the transfer process. In FIG. 8a, the line of stars indicated at (i) was patterned using a laser pulse energy of 1.04 mJ. In FIG. 8a, the line of stars indicated at (ii) was patterned using a laser pulse energy of 0.59 mJ. In FIG. 8a, the “LTL” letters indicated at (iii) were patterned using a laser pulse energy of 1.04 mJ. In FIG. 8a, the bubbles appearing as indicated at (v) (and elsewhere in the figure) were found to be located in the PDMS adhesion layer and not a result of the Alq₃ layer transfer process. In all cases, the shapes are well defined and the fluorescence of the Alq₃ is strong indication that the Alq₃ layer was not damaged during the transfer process.

FIG. 8b contains a photograph of the second surface of the donor substrate after laser irradiation and material transfer. The transfer appears to be complete and the surrounding Alq₃ layer has apparently not been damaged.

FIGS. 8c-f contain photographs of some of the Alq₃ squares and stars transferred to the acceptor substrate in greater magnification. The strong and uniform fluorescence of the Alq₃ shapes is a powerful indication that the transferred Alq₃ layer was not damaged by the transfer process. Additionally, the edges of the shapes are sharp and well defined indicating that the spatial control of the transfer process is accurate and precise.

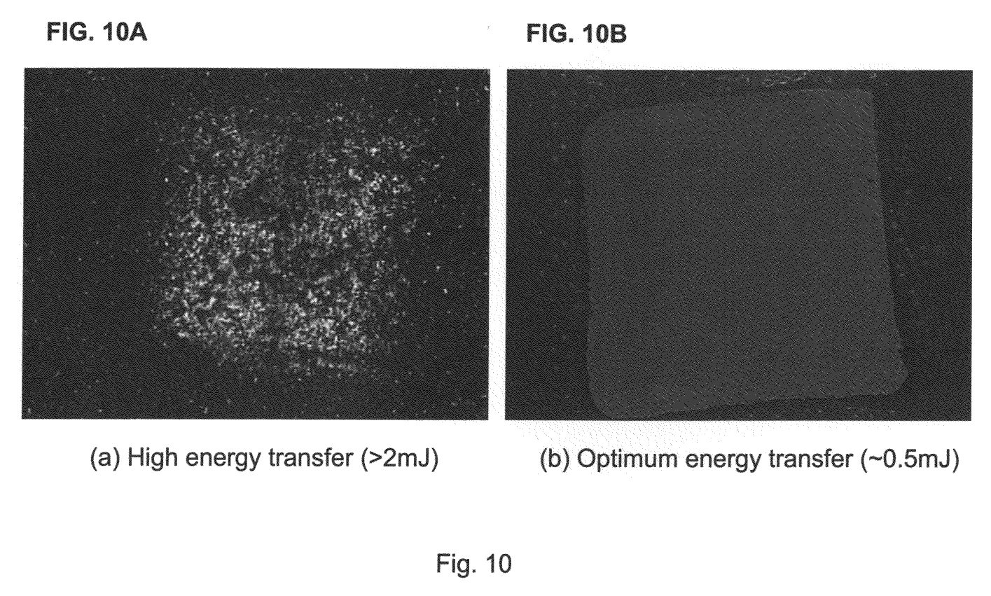

In the laser pulse energy range between about 0.3 mJ and about 2.0 mJ per pulse, the transferred Alq₃ layer did not exhibit damage (as would be indicated by a decrease in fluorescence) and did not exhibit cracking on its surface. In the laser pulse energy range above about 2.0 mJ per pulse, the transferred Alq₃ layer was found to exhibit damage. A typical example of damage that can result from excessive laser energy is given in FIG. 10 in which the fluorescence pattern from a damaged transfer FIG. 10a, is compared with the fluorescence pattern from a transfer carried out at lower energy, near what is expected to be the optimum laser energy for accurate pattern transfer, FIG. 10b.

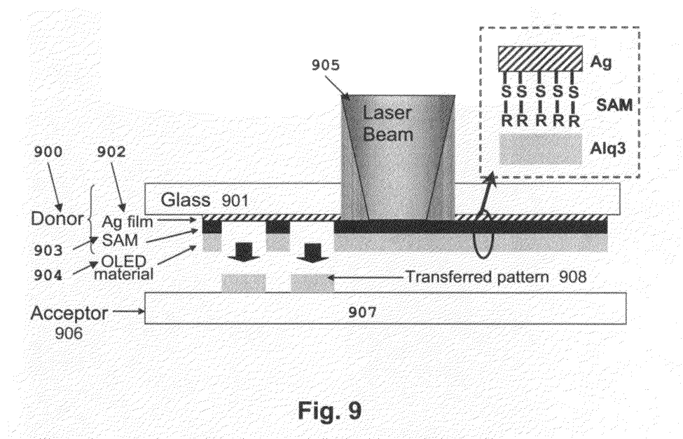

In some embodiments of the present invention, the light absorption layer formed by the nanoparticles protected by the SAM coating may be replaced with a continuous metal film protected with a SAM coating. FIG. 9 is a schematic illustration of a typical nanomaterial enabled laser induced transfer method according to some embodiments of the present invention. The donor substrate structure 900 has first and second surfaces. The second surface of the donor substrate may support a multilayer film comprised of the target material 904, SAM coating layer 903, nanomaterial metal film 902, formed on glass substrate 901. Typically, the nanomaterial metal layer may be about 50 nm to about 100 nm in thickness. The acceptor substrate structure 906 may be any useful material. In some embodiments of the present invention, the acceptor substrate structure 906 may be a substrate material 907 with coatings or other useful structures for the manufacture of the target pattern. The donor substrate structure 900 may be placed face down on the acceptor substrate structure 906. The surfaces may be in close proximity or they may be touching. A Nd:YAG laser beam 905 may be directed toward the first surface (top) of the donor substrate 901. The laser properties are chosen such that the radiation does not react strongly with the donor substrate material but may be strongly absorbed by the nanomaterial metal film 902, causing heat to be transferred to the SAM layer 903. The pressure may rapidly build from the expansion of volatile species such as desorbed SAM, residual organic solvent, and trapped air. The increased pressure will typically eject the nanoparticle film to detach the target material 904 from the donor substrate. The target material may then impinge upon the first surface of the acceptor substrate 907 and result in the formation of the desired pattern 908.

In FIG. 9, the nanomaterial metal film may be a thin film of suitable metal. Examples of suitable metal films may include, but are not limited to Au, Ag, Pt, Pd, Cu, Ni, Cr, Ti, Fe, Zn, W, Si, and Al among others. The SAM coating may be an alkanethiol and may be several nanometers in length depending on the number of carbon atoms in the alkane chain. It is well known that such alkanethiols form highly stable and uniform SAM structures through strong —S bonds at the interface with the nanomaterial metal thin film. For example, see Majumder et al, J. Chem. Phys., Vol. 117, pp. 2819-2822 (2002), the entire contents of which is incorporated herein by reference for all purposes. The alkanethiol may begin to desorb from the nanomaterial metal surface in the temperature range from about 150° C. to about 250° C. A pulsed laser or a continuous wave laser may be used to control the temperature at the impingement point of the laser spot to be in the range slightly above the desorption temperature of the alkanethiol and below the temperature where the Alq₃ begins to exhibit damage. This may result in the efficient transfer of the Alq₃ to the acceptor substrate without damage.

In some embodiments of the present invention, the laser irradiation is used to remove material that is not desired in the final pattern by using the LIFT technique. In this case, the donor substrate structure includes material layers useful in the final device. As an example, glass may be used as the substrate. A light absorption layer of nanoparticles protected with a SAM coating may be applied according to techniques described elsewhere herein. The target material is typically deposited over the nanoparticle matrix discussed elsewhere herein. The donor substrate structure may be placed in close proximity or in intimate contact with an acceptor substrate structure. The laser beam may be used to transfer material from the donor substrate structure to the acceptor substrate structure. However, the material that is transferred in this case is material that is not desired in the final pattern. The remaining material on the donor substrate structure forms the desired pattern and the donor substrate structure is used in the manufacture of the intended device.

The use of a laser beam as the energy source for the heating and evaporation of the nanomaterial has the benefit of not requiring a mask as an intermediate pattern generation mechanism. However, the benefits of the low melting and low evaporation properties of the nanomaterials described herein may be realized using other energy sources in conjunction with a mask. In some embodiments of the present invention, the donor substrate structure may be prepared as discussed previously. A mask having the desired pattern may be placed in close proximity or in intimate contact with the first surface of the donor substrate structure or may be placed before an objective lens used for scaling down the projection of the mask. This has been illustrated by the star shaped patterns in FIGS. 7 and 8. The mask may be suitable for forming a pattern of transferred material or may be suitable for removing material not required for the final pattern. An energy source is typically directed through the mask and through the donor substrate material. The energy source may comprise a pulsed lamp, a continuous wave lamp, or an LED, among others. The energy that passes through the mask is typically absorbed by the nanomaterial light absorption layer. The energy absorption heats the nanomaterial and the surface molecular coating causing melting and/or evaporation. The evaporation of the material is typically sufficient to cause the target material to be transferred to the acceptor substrate structure. The advantageous properties of the nanomaterial matrix may allow material transfer at energy fluences below the damage threshold of the target material. This technique may be particularly advantageous for the mass production of temperature sensitive devices.

Although various embodiments which incorporate the teachings of the present invention have been shown and described in detail herein, those skilled in the art can readily devise many other varied embodiments that still incorporate these teachings.

What is claimed is:

1. A donor substrate for laser induced forward transfer comprising a substrate having on one face thereof a matrix layer and a deposition material layer atop said matrix layer, wherein said substrate is sufficiently transparent to transmit light therethrough to said matrix layer at a wavelength and intensity so as to cause ejection of said deposition material from said substrate; and
wherein said matrix layer is a film comprising nanoparticles.

2. A donor substrate as in claim 1 wherein said nanoparticles have a coating thereon.

3. A donor substrate as in claim 2 wherein said coating is a self-assembled monolayer.

4. A donor substrate as in claim 1 wherein said nanoparticle film comprises nanoparticles with diameters in the range from about 30 nanometers to about 40 nanometers.
